(19) United States
(12) Patent Application Publication
(10) Pub. No.: US 2026/0044410 A1
(43) Pub. Date: Feb. 12, 2026

(54) SPARSITY POISON FOR UNCORRECTABLE MEMORY ERRORS

(71) Applicant: Advanced Micro Devices, Inc., Santa Clara, CA (US)

(72) Inventors: Sudhanva GURUMURTHI, Austin, TX (US); Vilas SRIDHARAN, Boxborough, MA (US)

(21) Appl. No.: 18/799,224

(22) Filed: Aug. 9, 2024

(51) Int. Cl. G06F 11/10; G06F 11/07; G06F 17/16

(52) U.S. Cl. CPC G06F 11/1016; G06F 11/0793; G06F 17/16

(57) ABSTRACT

Embodiments herein can avoid shutting down a process that receives poison data that includes an uncorrectable error by converting the poison data into sparsity data. In one embodiment, the sparsity data comprises zeros that replace the bits of the poison data. Compute circuitry can then perform its task as normal, but instead using the zeros of the sparsity data instead of the poison data. Because the poison data is now zeros, they have a reduced negative effect on the process being performed by the compute circuitry.

### TECHNICAL FIELD

The embodiments presented herein relate to handling uncorrectable errors in data read from memory.

### BACKGROUND

Creating error correction schemes for many different hardware architectures is difficult. While error correction codes can be used to detect errors, the overhead required to correct those errors can be prohibitively expensive in the terms of data bandwidth. As such, many hardware architectures can correct only certain bit patterns while many other errors are not correctable (referred to herein as detectable but uncorrectable errors (DUE)). When a memory controller detects a DUE, it typically marks or encodes the data as poison. Once the poison data reaches the compute circuitry, it identifies the data as being corrupted and informs the software stack (e.g., an operating system). The software stack then shuts down the process or kernel that initiated the request for the poison data.

### SUMMARY

One embodiment described herein is a system that includes compute circuitry configured to perform an operation that is part of a software application, a memory controller configured to detect an uncorrectable error in data read from a memory, and first circuitry configured to mark the data as poison data and convert the poison data into sparsity poison by zeroing out the data, wherein the compute circuitry is configured to perform the operation using the sparsity poison.

Another embodiment described herein is a computing device that includes a shader engine in a graphics processing unit (GPU), a core in a central processing unit (CPU), or a data processing engine (DPE) or artificial intelligence (AI) engine in a system on a chip (SoC) or a field programmable gate array (FPGA) configured to perform an operation that is part of a software application, a memory controller configured to detect an uncorrectable error in data read from a memory, and first circuitry configured to mark the data as poison data and convert the poison data into sparsity poison by zeroing out the data, wherein the shader engine, the core, the DPE, or the AI engine is configured to perform the operation using the sparsity poison.

Another embodiment described herein is a system that includes a memory controller configured to detect an uncorrectable error in data read from a memory and mark the data as poison data; and compute circuitry configured to perform an operation that is part of a software application using the poison data to generate processed data and provide the processed data to the software application. Moreover, the software application is configured to convert the poison data into sparsity data by zeroing out the processed data corresponding to the poison data.

### BRIEF DESCRIPTION OF DRAWINGS

FIG. 1 illustrates a system for converting poison data into sparsity poison, according to one embodiment herein.

FIG. 2 is a flowchart for converting poison data into sparsity poison, according to one embodiment herein.

FIG. 3 is a flowchart for converting poison data into sparsity poison at a memory controller, according to one embodiment herein.

FIG. 4 is a flowchart for converting poison data into sparsity poison at compute circuitry, according to one embodiment herein.

FIG. 5 is a flowchart for converting poison data into sparsity poison in software, according to one embodiment herein.

FIG. 6 is a block diagram of a hardware accelerator array, according to an example.

FIG. 7 is a block diagram of a data processing engine, according to an example.

### DETAILED DESCRIPTION

Embodiments herein describe converting poison data (e.g., data with an uncorrectable error) into sparsity poison. When a requestor, such as compute circuitry (e.g., a shader engine in a graphics processing unit (GPU), a core in a central processing unit (CPU), or a data processing engine (DPE) or artificial intelligence (AI) engine in a system on a chip (SoC) or a field programmable gate array (FPGA)) requests data from memory, the data may be corrupted.

The memory architecture can include error correction code (ECC) for detecting errors. While some errors may be correctable, many other may not be. A memory controller can use error detection circuitry to evaluate the ECC in retrieved data and detect an error. For example, GPUs provision a large amount of HBM and LPDDR DRAM to enable efficient Deep Neural Network (DNN) training by providing high capacity and high bandwidth storage for weights and activations. Neither of these memories are amenable to ECC that can correct many different types of errors compared to the state-of-the-art ECC for DDR DRAM, which increases the rate of DUEs from memory.

If the error is uncorrectable (i.e., a DUE), the memory controller marks or encodes the data as poison. However, shutting down the process or kernel that requested the data (as done traditionally) can result in the waste of any compute that has already been performed, which harms productivity. For example, AI training systems or distributed high performance compute systems may perform large training or compute tasks where shutting down a process or kernel can result in substantial loss of valuable training/compute data.

The embodiments herein can avoid shutting down a process that receives poison data by converting the poison data into sparsity poison (or sparsity data). In one embodiment, the sparsity poison comprises zeros that replace the bits of the poison data (e.g., a byte, word, page, or multiple pages that include a DUE). The compute circuitry can then perform its task as normal, but use the zeros of the sparsity poison instead of the poison data. Because the poison data is now zeros, they have a reduced effect on the process being performed by the compute circuitry (e.g., AI training). Any loss of accuracy may be acceptable to the user application given the benefits of avoiding the loss of productivity by shutting down the process or kernel. For example, many DNN training algorithms can cope with using sparsity due to their closed-loop nature (e.g., using loss functions) to guide accurate training.

Moreover, converting poison data into sparsity poison can be done selectively. For example, for some address ranges, compute circuitry, tasks, or memory elements, using sparsity poison may be unacceptable, in which case the traditional methods of handling poison data can be used (e.g., shutting down the process or kernel). However, in the remaining situations, the system replaces the poison data with sparsity poison (e.g., zeros) to maintain productivity. In addition, it may be beneficial to convert poison data into sparsity poison at different locations such as in the memory controller, the compute circuitry, or in the software stack.

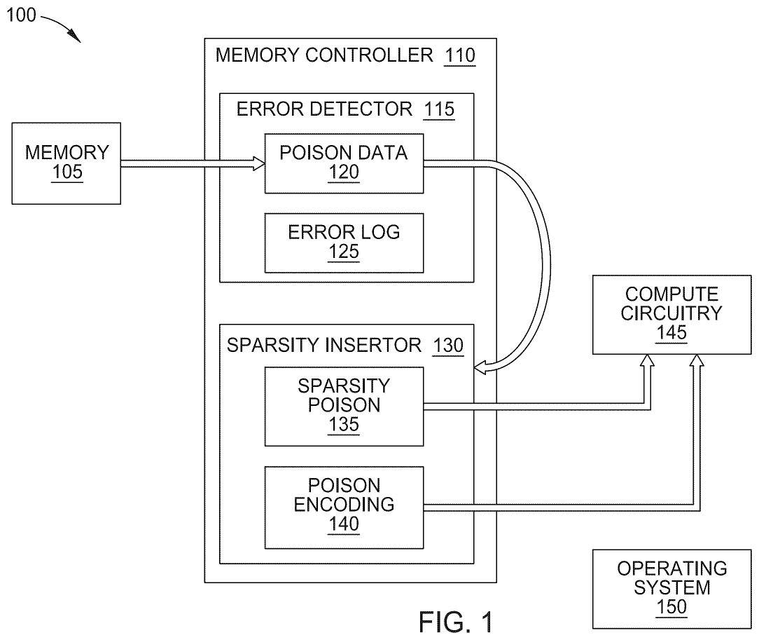

FIG. 1 illustrates a system 100 (e.g., a computing system or a computing device) for converting poison data into sparsity poison, according to one embodiment herein. FIG. 1 illustrates a memory 105, a memory controller 110, compute circuitry 145, and an operating system (OS) 150. The memory 105 can be any type of memory. For example, the memory 105 can be main memory such as DRAM (e.g., DDR), off-chip memory such as high bandwidth memory (HBM), or on-chip memory such as caches (e.g., SRAM). The embodiments herein are not limited to any particular type of memory—e.g., DRAM, SRAM, HBM, etc.—or if the memory is on the same chip (i.e., integrated circuit (IC)) or a different chip/IC as the compute circuitry 145.

The memory controller 110 reads data from, and writes data to, the memory 105 in response to instructions from the compute circuitry 145. If the memory 105 is SRAM, the memory controller may be a cache controller. But the embodiments herein are not limited to any particular type of controller.

The memory controller 110 includes an error detector 115 and a sparsity insertor 130. The error detector 115 is circuitry that can evaluate data as it is read from the memory 105 and determine, by evaluating an ECC in the data, whether the data has become corrupted. For example, bit flips may occur due to cosmic radiation or for other reasons. A common reason for bit flips is high-energy cosmic rays originating from outer space. When these particles interact with a computer's memory (e.g., memory 105), they can change the state of a stored bit.

There are many different types of ECCs for detecting errors in data, and the embodiments herein are not limited to any particular type. Instead, any ECC that permits the error detector 115 to detect an error is sufficient.

In addition to detecting the error, the error detector 115 can also determine whether the error is correctable. For example, some erroneous bit patterns may be correctable while others are not. DDRx DRAM used in CPUs provide an advanced ECC which allows the failure of any single DRAM device within a rank to be correctable. However, the HBM and LPDDR architectures make such advanced ECC prohibitively expensive, which means that the rate of memory DUEs is much higher with these memories. Thus, many memory systems can have errors that are not correctable (i.e., DUEs).

If it is correctable, the error detector 115 can correct the data. However, if an error is not correctable, the error detector 115 may pass the poison data 120 to the sparsity insertor 130. In addition, the error detector 115 can log uncorrectable errors that results in poison data 120 in an error log 125. The software in the system (e.g.,. the OS 150) can query this log to identify poison data and determine, for example, how often a memory 105 produces poison data and the amount of poison data 120.

The sparsity insertor 130 includes circuitry that converts poison data 120 into sparsity poison 135. In one embodiment, the sparsity insertor 130 converts the corrupted poison data 120 into zeros. That is, the poison data 120 can include a mix of ones and zeros (where at least one of those bits is corrupted). The sparsity insertor 130 can convert these bits into zeros to generate the sparsity poison 135. This can be done at different levels of granularity. For example, the sparsity insertor 130 may convert a byte, a word, a page, or multiple pages that include a DUE (or multiple DUEs) into zeros.

In addition, the sparsity insertor 130 marks or encodes the data as poison data 120. For example, the error detector 115 can add metadata (e.g., a poison encoding 140) to the poison data 120 that labels it as poison. Downstream circuitry, e.g., the compute circuitry 145, can use the poison encoding 140 to identify when data received from the memory controller 110 contains a DUE (i.e., is poison). That is, the sparsity poison 135 along with the poison encoding 140 can be forwarded to the compute circuitry 145.

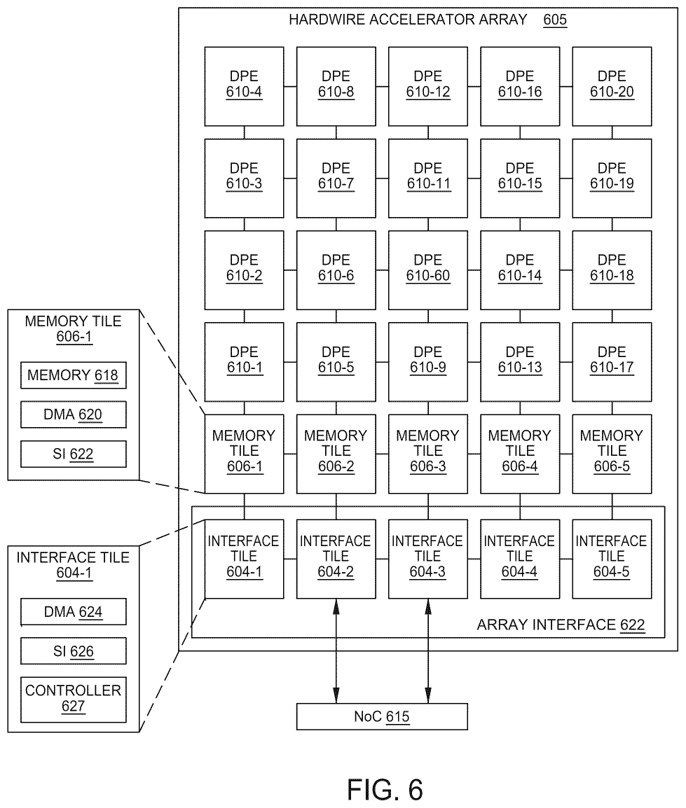

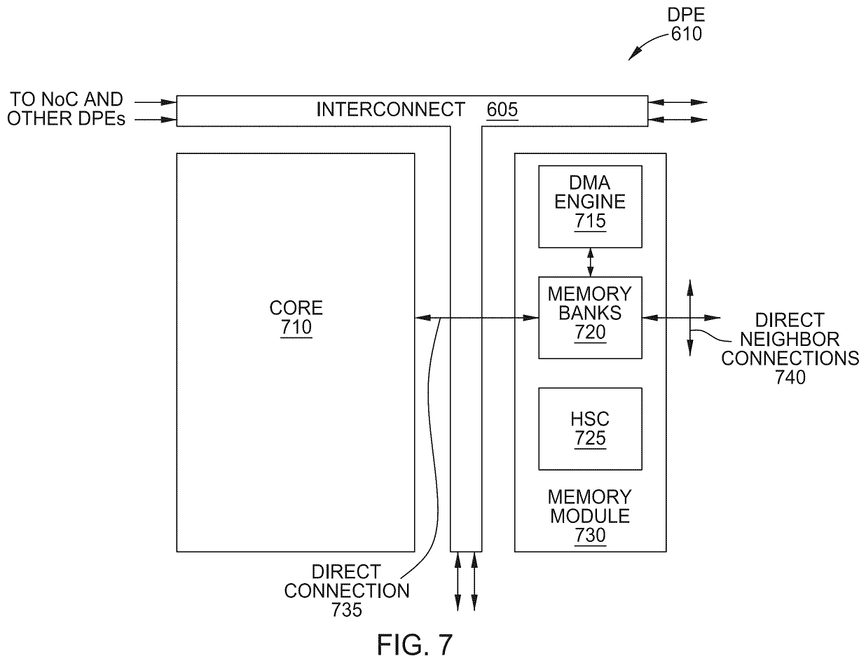

The compute circuitry 145 can be a shader engine in a GPU, a core in a CPU, a DPE/AI engine in a SoC (which is discussed below in FIGS. 6 and 7) or a FPGA, and the like. The process being performed by the compute circuitry 145 using the data retrieved from the memory 105 can depend on the type of the compute circuitry 145 (e.g., matrix multiplications, ALU operations, etc.) as well as the type of user application being executed in the compute circuitry 145 (e.g., training an AI model, inference, performing operations for a distributed high performance compute system, etc.).

The compute circuitry 145 can receive the sparsity poison 135 and perform its normal operation as if the data did not have a DUE. For example, the compute circuitry 145 may perform a matrix multiplication on the sparsity poison 135. However, since the sparsity poison 135 contains zeros, the matrix multiplications would result in zeros. While this may reduce the accuracy of the task or process being performed by the compute circuitry 145, this may be preferred given the alternative (or traditional) method of handling DUEs where the poison data 120 causes the compute circuitry 145 to throw a machine check exception (MCE) which results in the software stack (e.g., the OS 150) shutting down the process or kernel executing on the compute circuitry 145, losing the data that has been processed thus far.

With many AI training applications, loss functions are used to judge the accuracy of the training. The AI training application can use the loss functions to determine whether gradients are changing in the desired direction. For example, processing the sparsity poison 135 in the compute circuitry 145 may not cause these gradients to move in an undesirable direction, as indicated by the loss functions. As such, processing the sparsity poison 135, rather than throwing an MCE to shut down the process, may be desirable since training may complete much faster, even in the presence of DUEs without sacrificing too much accuracy.

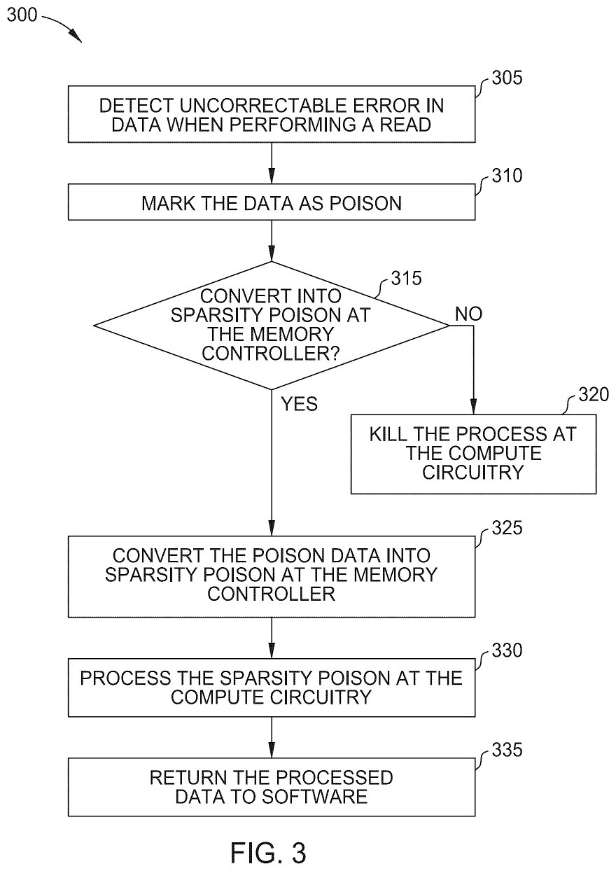

However, for some process or applications it may be desirable to shut down the process or kernel instead of using the sparsity poison 135. Or in another case, there may be too many DUEs where the sparsity poison 135 starts to have a negative impact on the user application. In that case, the system 100 can make an intelligent decision on when to convert poison data 120 into sparsity poison 135 and when not to. That is, the system 100 can instead determine to shut down the process or kernel rather than continue to use sparsity poison 135. Examples of this are discussed in more detail in FIGS. 3-5 below.

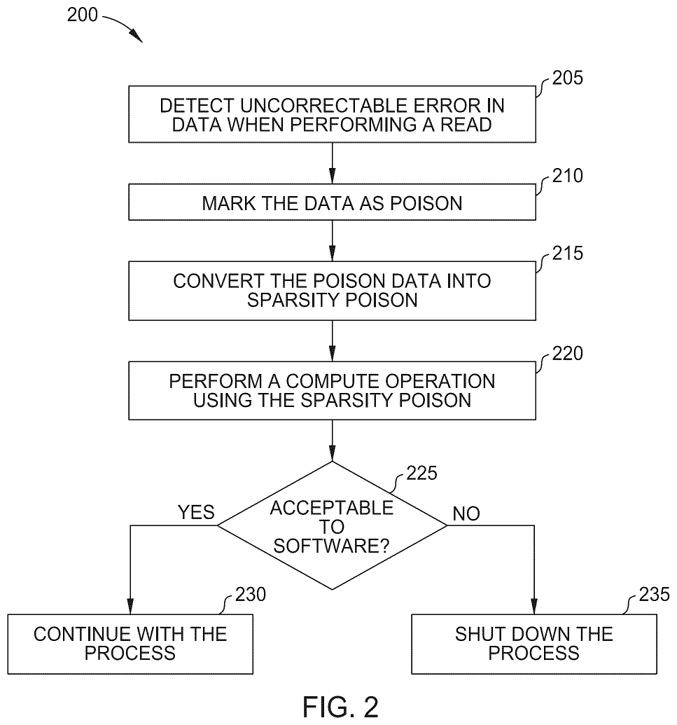

FIG. 2 is a flowchart of a method 200 for converting poison data into sparsity poison, according to one embodiment herein. At block 205, circuitry (e.g., the error detector 115 in FIG. 1) detects an uncorrectable error (e.g., DUE) in data when performing a read. For example, the error detector may be in a memory controller that was instructed by a compute circuitry (e.g., the compute circuitry 145 in FIG. 1) to read data from a memory (e.g., the memory 105).

As mentioned above, the memory may be any type of memory (e.g., DRAM, SRAM, HBM, etc.) and any suitable ECC can be used to detect an error and determine whether that error is correctable or not.

At block 210, circuitry (e.g., the sparsity insertor 130 in FIG. 1) marks the data as poison. In one embodiment, the circuitry generates metadata (e.g., the poison encoding 140 in FIG. 1) that informs downstream circuitry that the data has a DUE (e.g., is poison).

At block 215, circuitry (e.g., the sparsity insertor 130 in FIG. 1) converts the poison data into sparse poison. Although this data is still considered poison (and is marked as such), the bit values have been zeroed out (e.g., the ones and zeros in the poison data have been converted to zeros).

As mentioned above, converting poison data into sparsity poison can be done at different levels of granularity (e.g., a byte, word, page, or multiple pages that include a DUE). For example, the error detector may detect that a particular byte of data read from the memory has a DUE. In that case, only that byte of data is marked as poison and converted into sparsity poison. However, in another example, the error detector may detect that a particular page of data has one or more DUEs. In that case, the entire page is marked as poison and converted into sparsity poison (e.g., zeros). As such, the amount of data that is marked as poison and converted into sparsity poison can vary.

At block 220, compute circuitry performs a compute operation using the sparsity poison. The compute operation may be performed as part of a software application (e.g., a user application). This compute operation can be a matrix multiplication (as is typical in AI training algorithms), arithmetic operations part of a ALU, and the like. Put differently, the compute circuitry may process the sparsity poison the same it would if the data was not poison. However, the compute circuitry may mark that the operation was performed using sparsity poison data. This could be stored in an error log or other database that is accessible to the software stack. Moreover, other circuitry such as the memory controller may log when sparsity poison data is used to perform a compute operation.

At block 225, the software application determines whether performing the compute operation using the sparsity poison is acceptable. For example, an AI training application can use the loss functions to determine whether gradients are changing in the desired direction. If the gradients do not indicate a significant reduction in accuracy when using sparsity poison, then the AI training application can decide to let the process continue at block 230. In other examples, the software may use other performance metrics such as statistical metrics to determine whether performing the compute operation using some sparsity poison results in sufficiently accurate results.

However, if the software determines that performing the compute operation using sparsity poison does not result in sufficiently accurate results, the method 200 can proceed to block 235 where the software shuts down the process (e.g., stops the kernel executing on the compute circuitry).

As such, the method 200 gives the software (e.g., a user application) power to decide whether to use sparsity poison to perform a compute operation rather than simply shutting down the compute operation any time a DUE is encountered. Moreover, the method 200 provides metrics that the user can implement to determine how much sparsity poison is tolerated. Moreover, the user application can set one or more thresholds for sparsity poison (e.g., an acceptable rate of DUE being detected). For example, it may be acceptable that a single cache line is zeroed out into sparsity data, but perhaps not if an entire DRAM row or bank of cache lines were zeroed out. If the system detects too many DUEs or determines the sparsity poison is causing the compute operations to provide inaccurate results, the software can shut down the process or kernel performing the compute operation.

FIG. 3 is a flowchart of a method 300 for converting poison data into sparsity poison at a memory controller, according to one embodiment herein. At block 305, circuitry in the memory controller detects an uncorrectable error (e.g., DUE) in data when performing a read.

As mentioned above, the memory may be any type of memory (e.g., DRAM, SRAM, HBM, etc.) and any suitable ECC can be used to detect an error and determine whether that error is correctable or not.

At block 310, the memory controller marks the data as poison. In one embodiment, the circuitry generates metadata (e.g., the poison encoding 140 in FIG. 1) that informs downstream compute circuitry that the data has a DUE (e.g., is poison).

At block 315, the memory controller determines whether to convert the poison data into sparsity poison or to maintain the poison data in its current state. For example, software (or a user) may set parameters when the memory controller should, or should not, convert poison data into sparsity data. These parameters may include memory address ranges, the type of the requestor, the particular task, or the type of the memory. For example, different types of data may be stored at different memory addresses. For instance, for memory address ranges that store activations, it may be acceptable to convert any poison data into sparsity poison so the compute operation can continue. However, for memory address ranges that store weights or firmware code, the memory controller is programmed to keep data with a DUE as poison data (which will shut down the operation as discussed below). Thus, System Physical Address (SPA) ranges can be used to define when to convert poison data into sparsity poison.

In another example, different kernels or operations may be performed on different requestors (e.g., the compute circuitry). If the data being read from memory was requested by a requestor that performs a high-precision calculation, then the memory controller may be programmed not to convert this data into sparsity poison. In contrast, if the requestor performs an operation that can consume sparsity poison without losing any (or much) accuracy, the memory controller can be programmed to convert the poison data into sparsity poison.

In another example, the memory controller may be programmed to convert (or not convert) the poison data into sparsity poison depending on the task. For example, the read request may include a task label indicating how the data will be used by the requestor (e.g., a safety critical application versus a media application in a vehicle). When an DUE is detected, the memory controller can use a look-up table or a hashing algorithm to determine whether the poison data can be converted into sparsity data depending on the task being performed using the data.

In yet another example, the memory controller may (or may not) convert the poison data into sparsity poison depending on the memory the data was read from. For instance, different types of data may be stored in different types of memory elements (e.g., different types of DDR, SRAM versus DRAM, SRAM versus HBM, etc.). Data stored in one type of memory may be more important to an operation than data stored in another type of memory. Thus, when a DUE is detected in data received from a memory storing more important data, the memory controller may not convert this poison data into sparsity poison since it could have a serious impact on downstream compute operations. In contrast, poison data read from a memory storing less important data can be converted into sparsity data so the operation can continue.

If the memory controller determines not to convert the poison data into sparsity poison, the method 300 proceeds to block 320 where the poison data is transmitted to the downstream compute circuitry which shuts down the process (e.g., stops the kernel). For example, the compute circuitry can transmit an MCE which results in the software stack shutting down the process or kernel executing on the compute circuitry, losing the data that has been processed thus far.

In contrast, if the memory controller determines to convert the poison data into sparsity poison, the method 300 proceeds to block 325 where the memory controller converts the poison data into sparsity poison by converting the data into zeros and then transmit the sparsity poison to the compute circuitry.

At block 330, the compute circuitry processes the sparsity poison. That is, the compute circuitry performs a compute operation using the sparsity poison, such as the ones discussed in block 220 of FIG. 2. The compute circuitry may process the sparsity poison the same it would if the data was not poison.

In one embodiment, the memory controller tracks or logs when a DUE was detected. The memory controller can also track or log when poison data with a DUE was converted into sparsity poison. That way, the software stack can identify when compute operations were performed using sparsity poison. This may help the software stack ensure (e.g., by testing) that the compute operations maintained a desired level of accuracy.

At block 335, the compute circuitry returns the processed data (which was generated using sparsity poison) to software. The software can check the log to determine whether the processed data was generated using sparsity poison. Or the compute circuitry may flag the processed data so the software knows it should check the logs maintained by the memory controller to determine what data (and how much data) was converted into sparsity poison. The software can then determine whether to keep (and use) the processed data or to discard the data. That is, the software can decide whether to permit the process to continue to run or whether to shut down the process as discussed in blocks 225-235 of FIG. 2.

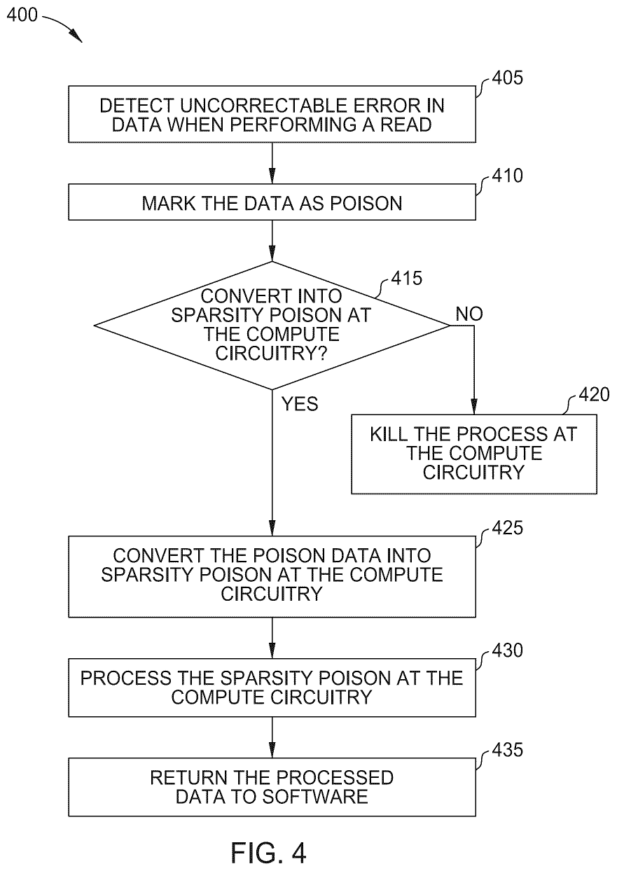

FIG. 4 is a flowchart of a method 400 for converting poison data into sparsity poison at the compute circuitry, according to one embodiment herein. That is, unlike in FIG. 3 where the memory controller determines whether to convert poison data into sparsity poison, here, that decision is delayed until reaching the compute circuitry.

At block 405, circuitry in the memory controller detects an uncorrectable error (e.g., DUE) in data when performing a read.

As mentioned above, the memory may be any type of memory (e.g., DRAM, SRAM, HBM, etc.) and any suitable ECC can be used to detect an error and determine whether that error is correctable or not.

At block 410, the memory controller marks the data as poison. In one embodiment, the circuitry generates metadata (e.g., the poison encoding 140 in FIG. 1) that informs downstream compute circuitry that the data has a DUE (e.g., is poison). The memory controller then forwards the poison data (and an encoding or marking indicating the data is poison) to the compute circuitry.

At block 415, the compute circuitry determines whether to convert the poison data into sparsity poison or maintain the poison data in its current state. In one embodiment, the compute circuitry can include specialized circuitry for first determining whether to convert the poison data into sparsity poison before the data reaches the circuitry in the compute circuitry that performs the compute operation (e.g., a matrix multiplier or ALU).

As described in FIG. 3, software (or a user) may set parameters when the compute circuitry should, or should not, convert poison data into sparsity data. These parameters may include memory address ranges, the type of the requestor, the particular task, or the type of the memory. For example, different types of data may be stored at different memory addresses. For instance, for memory address ranges that store activations, it may be acceptable to convert any poison data into sparsity poison so the compute operation can continue. However, for memory address ranges that store weights or firmware code, the compute circuitry is programmed to keep data with a DUE as poison data (which will shut down the operation as discussed below).

In another example, the compute circuitry may convert the poison data into sparsity poison depending on the kernel the compute circuitry is executing. If the data being read from memory is being used by a kernel that performs a high-precision calculation, then the compute circuitry may not to convert this data into sparsity poison. In contrast, if the kernel performs an operation that can consume sparsity poison without losing any (or much) accuracy, the compute circuitry converts the poison data into sparsity poison.

In another example, the compute circuitry may be programmed to convert (or not convert) the poison data into sparsity poison depending on the task. For example, the compute circuitry may know the task or compute operation that it will perform using the data (e.g., a safety critical application versus a media application). When an DUE is detected, the compute circuitry can use a look-up table or a hashing algorithm to determine whether the poison data can be converted into sparsity data depending on the task it will perform using the data.

In yet another example, the compute circuitry may (or may not) convert the poison data into sparsity poison depending on the memory the data was read from. In this case, the memory controller may tell the compute circuitry where the data came from. For instance, different type of data may be stored in different types of memory elements (e.g., different types of DDR, SRAM versus DRAM, SRAM versus HBM, etc.). Data stored in one type of memory may be more important to an operation than data stored in another type of memory. Thus, when a DUE is detected in data received from a memory storing more important data, the compute circuitry may not convert this poison data into sparsity poison since it could have a serious impact on downstream compute operations. In contrast, poison data read from a memory storing less important data can be converted into sparsity data so the operation can continue.

If the compute circuitry determines not to convert the poison data into sparsity poison, the method 400 proceeds to block 420 where the compute circuitry shuts down the process (e.g., stops the kernel). For example, the compute circuitry can transmit an MCE which results in the software stack shutting down the process or kernel executing on the compute circuitry, losing the data that has been processed thus far.

In contrast, if the compute circuitry determines to convert the poison data into sparsity poison, the method 400 proceeds to block 425 where the compute circuitry converts the poison data into sparsity poison by converting the data into zeros.

At block 430, the compute circuitry processes the sparsity poison. That is, the compute circuitry performs a compute operation using the sparsity poison, such as the ones discussed in block 220 of FIG. 2. The compute circuitry may process the sparsity poison the same it would if the data was not poison.

In one embodiment, the compute circuitry tracks or logs when a DUE was detected. The compute circuitry can also track or log when poison data with a DUE was converted into sparsity poison. That way, the software stack can identify when compute operations were performed using sparsity poison. This may help the software stack ensure (e.g., by testing) that the compute operations maintained a desired level of accuracy.

At block 435, the compute circuitry returns the processed data (which was generated using sparsity poison) to software. The software can check the log to determine whether the processed data was generated using sparsity poison. Or the compute circuitry may flag the process data so the software knows it should check the logs maintained by the compute circuitry to determine what data (and how much data) was converted into sparsity poison. The software can then determine whether to keep (and use) the processed data or to discard the data. That is, the software can decided whether to permit the process to continue to run or whether to shut down the process as discussed in blocks 225-235 of FIG. 2.

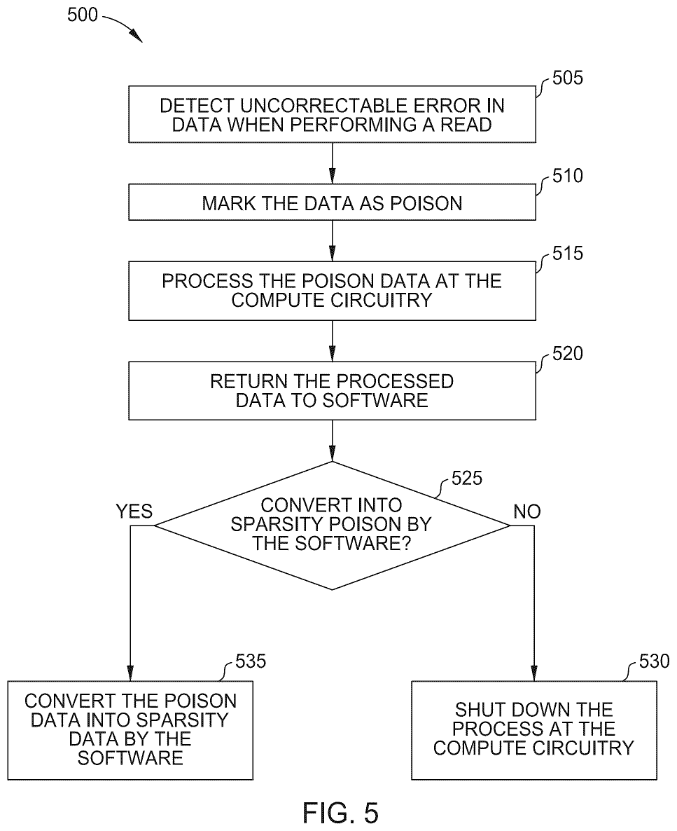

FIG. 5 is a flowchart of a method 500 for converting poison data into sparsity poison in software, according to one embodiment herein. That is, unlike in FIG. 3 or 4 where the memory controller or compute circuitry determines whether to convert poison data into sparsity poison, here, that decision is delayed until reaching the software.

At block 505, circuitry in the memory controller detects an uncorrectable error (e.g., DUE) in data when performing a read.

As mentioned above, the memory may be any type of memory (e.g., DRAM, SRAM, HBM, etc.) and any suitable ECC can be used to detect an error and determine whether that error is correctable or not.

At block 510, the memory controller marks the data as poison. In one embodiment, the circuitry generates metadata (e.g., the poison encoding 140 in FIG. 1) that informs downstream compute circuitry that the data has a DUE (e.g., is poison). The memory controller then forwards the poison data (and an encoding or marking indicating the data is poison) to the compute circuitry.

At block 515, the compute circuitry processes the poison data. That is, the compute circuitry performs a compute operation using the poison data without first converting the data into sparsity data. That is, the compute circuitry may process the poison data the same it would if the data was not poison. Thus, unlike in FIGS. 2-4 where the data is first converted into sparsity poison before being processed by the compute circuitry, here it is not.

In one embodiment, the compute circuitry or memory controller tracks or logs when a DUE was detected. That way, the software stack can identify when compute operations were performed using poison data. This may help the software stack decide how to proceed as described below.

At block 520, the compute circuitry returns the processed data (which was generated using poison data) to software.

At block 525, the software determines whether to convert the processed data into sparsity data (e.g., to zero out the processed data). The software can check the log to determine whether the processed data was generated using poison data. Or the compute circuitry may flag the processed data so the software knows it should check the logs maintained by the compute circuitry or the memory controller to determine how much poison data was used. The software can then determine whether to convert the poison, processed data into sparsity data, or to discard the data.

As described in FIGS. 3 and 4, the software may use one or more parameters to determine when to convert poison data received from the compute circuitry into sparsity data. These parameters may include memory address ranges, the type of the requestor, the particular task, or the type of the memory. For example, different types of data may be stored at different memory addresses. For instance, for memory address ranges that store activations, it may be acceptable to convert any poison data into sparsity poison so the compute operation can continue (e.g., the sparsity poison can be used to perform follow up calculations in an AI training application or a distributed compute application). However, for memory address ranges that store weights or firmware code, the compute circuitry is programmed to keep data with a DUE as poison data (which will shut down the operation as discussed below).

In another example, the software may convert the poison data into sparsity poison depending on the kernel the compute circuitry was executing at block 515. If the data being read from memory is being used by a kernel that performs a high-precision calculation, then the software may not to convert this data into sparsity poison. In contrast, if the kernel performs an operation that can consume sparsity poison without losing any (or much) accuracy, the software converts the poison data into sparsity poison.

In another example, the software may convert (or not convert) the poison data into sparsity poison depending on the task. For example, the software knows the task or compute operation that the data is being used for (e.g., a safety critical application versus a media application). When an DUE is detected, the software can determine whether the poison data can be converted into sparsity data depending on the task the software is performing.

In yet another example, the software may (or may not) convert the poison data into sparsity poison depending on the memory the data was read from. In this case, the memory controller may tell the software where the data came from. For instance, different type of data may be stored in different types of memory elements (e.g., different types of DDR, SRAM versus DRAM, SRAM versus HBM, etc.). Data stored in one type of memory may be more important to an operation than data stored in another type of memory. Thus, when a DUE is detected in data received from a memory storing more important data, the software may not convert this poison data into sparsity poison since it could have a serious impact on downstream compute operations. In contrast, poison data read from a memory storing less important data can be converted into sparsity data so the operation can continue.

If the software determines not to convert the poison, processed data into sparsity poison, the method 500 proceeds to block 530 where the software shuts down the process (e.g., stops the kernel). For example, the software can shut down the process or kernel executing on the compute circuitry, losing the data that has been processed thus far.

In contrast, if the software determines to convert the poison data into sparsity data, the method 500 proceeds to block 535 where the software converts the poison data into sparsity data by converting the processed data derived from the poison data into zeros. This sparsity data can then be used to perform other operations within the task (or tasks) being performed by the software (e.g., AI training).

FIG. 6 is a block diagram of a hardware accelerator array 605, according to an example. In this example, the hardware accelerator array 605 includes a plurality of circuit blocks, or tiles, illustrated here as the DPEs 610 (also referred to as DPE tiles or compute tiles, or as AI engines), interface tiles 604, and memory tiles 606. Memory tiles 606 may be referred to as shared memory and/or shared memory tiles. Interface tiles 604 may be referred to as shim tiles, and may be collectively referred to as an array interface 628. The hardware accelerator array 605 is coupled to a NoC 615, which couples the array 605 to other components in the same IC (or same SoC) such as a CPU, graphics processing unit (GPU), memory controller, and the like. FIG. 6 further illustrates that the interface tiles 604 communicatively couple the other tiles in the hardware accelerator array 605 (i.e., the DPEs 610 and memory tiles 606) to the NoC 615.

DPEs 610 can include one or more processing cores, program memory (PM), data memory (DM), DMA circuitry, and stream interconnect (SI) circuitry. Specifically, the DPEs 610 are one example of the compute circuitry 145 in FIG. 1. For example, the core(s) is the DPEs 610 can execute program code stored in the PM. The core(s) may include, without limitation, a scalar processor and/or a vector processor. DM may be referred to herein as local memory or local data memory, in contrast to the memory tiles 606 which have memory that is external to the DPE tiles, but still within the hardware accelerator array 605.

The core(s) in the DPEs 610 may directly access data memory of other DPE tiles via DMA circuitry. The core(s) may also access DM of adjacent (or neighboring) DPEs 610 via DMA circuitry and/or DMA circuitry of the adjacent compute tiles. In one embodiment, DM in one DPE 610 and DM of adjacent DPE tiles may be presented to the core(s) as a unified region of memory. In one embodiment, the core(s) in one DPE 610 may access data memory of non-adjacent DPEs 610. Permitting cores to access data memory of other DPE tiles may be useful to share data amongst the DPEs 610.

The hardware accelerator array 605 may include direct core-to-core cascade connections amongst DPEs 610. Direct core-to-core cascade connections may include unidirectional and/or bidirectional direct connections. Core-to-core cascade connections may be useful to share data amongst cores of the DPEs 610 with relatively low latency (e.g., the data does not traverse stream interconnect circuitry, and the data does not need to be written to data memory of an originating DPE and read by a recipient or destination DPE). For example, a direct core-to-core cascade connection may be useful to provide results from an accumulation register of a processing core of an originating DPE directly to a processing core(s) of a destination DPE.

In an embodiment, DPEs 610 do not include cache memory. Omitting cache memory may be useful to provide predictable/deterministic performance. Omitting cache memory may also be useful to reduce processing overhead associated with maintaining coherency among cache memories across the DPEs 610.

In an embodiment, processing cores of the DPE 610 do not utilize input interrupts. Omitting interrupts may be useful to permit the processing cores to operate uninterrupted. Omitting interrupts may also be useful to provide predictable and/or deterministic performance.

One or more DPEs 610 may include special purpose or specialized circuitry, or may be configured as special purpose or specialized compute tiles such as, without limitation, digital signal processing engines, cryptographic engines, forward error correction (FEC) engines, and/or artificial intelligence (AI) engines.

In an embodiment, the DPEs 610, or a subset thereof, are substantially identically to one another (i.e., homogenous compute tiles). Alternatively, one or more DPEs 610 may differ from one other more other DPEs 610 (i.e., heterogeneous compute tiles).

Memory tile 606-1 includes memory 618 (e.g., random access memory or RAM), DMA circuitry 620, and stream interconnect (SI) circuitry 622.

Memory tile 606-1 may lack or omit computational components such as an instruction processor or a core. In an embodiment, memory tiles 606, or a subset thereof, are substantially identical to one another (i.e., homogenous memory tiles). Alternatively, one or more memory tiles 606 may differ from one other more other memory tiles 606 (i.e., heterogeneous memory tiles). A memory tile 606 may be accessible to multiple DPEs 610. Memory tiles 606 may thus be referred to as shared memory.

Data may be moved between/amongst memory tiles 606 via DMA circuitry 620 and/or stream interconnect circuitry 622 of the respective memory tiles 606. Data may also be moved between/amongst data memory of a DPE 610 and memory 618 of a memory tile 606 via DMA circuitry and/or stream interconnect circuitry of the respective tiles. For example, DMA circuitry in a DPE 610 may read data from its data memory and forward the data to memory tile 606-1 in a write command, via stream interconnect circuitry in the DPE 610 and stream interconnect circuitry 622 in the memory tile 606. DMA circuitry 624 of memory tile 606-1 may then write the data to memory 618. As another example, DMA circuitry 620 of memory tile 606-1 may read data from memory 618 and forward the data to a DPE 610 in a write command, via stream interconnect circuitry 622 and stream interconnect circuitry in the DPE 610, and DMA circuitry in the DPE 610 can write the data to its data memory.

Array interface 628 interfaces between the hardware accelerator array 605 (e.g., DPEs 610 and memory tiles 606) and the NoC 615. Interface tile 604-1 (also referred to as a shim tile) includes DMA circuitry 624, stream interconnect circuitry 626, and a controller 627. Interface tiles 604 may be interconnected so that data may be propagated amongst interface tiles 604 bi-directionally. An interface tile 604 may operate as an interface for column of DPEs 610 (e.g., as an interface to the NoC 615). Interface tiles 604 may be connected such that data may propagate from one interface tile 604 to another interface tile 604 bi-directionally.

In an embodiment, interface tiles 604, or a subset thereof, are substantially identically to one another (i.e., homogenous interface tiles). Alternatively, one or more interface tiles 604 may differ from one other more other interface tiles 604 (i.e., heterogeneous interface tiles).

In an embodiment, one or more interface tiles 604 are configured as a NoC interface tile (e.g., as primary and/or secondary device) that interfaces between the DPEs 610 and the NoC 615 (e.g., to access other components in the SoC). While FIG. 6 illustrates coupling a subset of the interface tiles 604 to the NoC 615, in one embodiment, each of the interface tiles 604-1-5 is connected to the NoC 615. Doing so may permit different applications to control and use different columns of the memory tiles 606 and DPEs 610.

The controllers 627 in each of the interface tiles 604 can program or configure the DMA circuitry and stream interconnect circuitry of the hardware accelerator array 605 to provide desired functionality and/or connections to move data between/amongst DPEs 610, memory tiles 606, and the NoC 615. This enables the DPEs 610 to perform a desired operation (e.g., a ML function). The DMA circuitry and stream interconnect circuitry of the hardware accelerator array 605 may include, without limitation, switches and/or multiplexers that are configurable to establish signal paths within, amongst, and/or between tiles of the hardware accelerator array 605. The hardware accelerator array 605 may further include configurable Advanced eXtensible Interface (AXI) AXI interface circuitry. The DMA circuitry, the stream interconnect circuitry, and/or AXI interface circuitry may be configured or programmed by storing configuration parameters in configuration registers, configuration memory (e.g., configuration random access memory or CRAM), and/or eFuses, and coupling read outputs of the configuration registers, CRAM, and/or eFuses to functional circuitry (e.g., to a control input of a multiplexer or switch), to maintain the functional circuitry in a desired configuration or state. In an embodiment, the core(s) of DPEs 610 configure the DMA circuitry and stream interconnect circuitry of the respective DPEs 610 based on core code stored in PM of the respective DPEs 610. The controllers 627 in each column can configure DMA circuitry and stream interconnect circuitry of memory tiles 606 and interface tiles 604 in that particular column based on controller code. Moreover, in one embodiment, the controllers 627 in each column can configure DMA circuitry for the DPEs 610 in their respective columns.

While FIG. 6 illustrates a controller 627 per column, there may be other arrangements where multiple controllers are tasked with controlling different subsets of tiles in the hardware accelerator. For example, the array may include a controller in every other column, where each controller is tasked with controlling tiles in two columns. In another example, there may be multiple controllers per column where each controller is tasked with controlling a different subset of tiles within the column.

In one embodiment, the controllers 627 are microprocessors. The controllers 627 can be hardened circuitry that executes software code (or firmware) that controls the DPE. In one embodiment, the only task of the controllers 627 is to control and orchestrate the functions performed by the array 605. However, in other embodiments, other tasks may be performed by the controllers 627, such as moving data into and out of the array 605 using the NoC 615. For example, the controllers 627 may communicate with a memory controller (not shown) to store data in, or retrieve data from, the memory (either in the same IC as the array 605 or on a different IC). In this example, the controllers 627 may execute different specialized code depending on the task a CPU has currently assigned to the array 605.

The hardware accelerator array 605 may include a hierarchical memory structure. For example, data memory of the DPEs 610 may represent a first level (L1) of memory, memory 618 of memory tiles 606 may represent a second level (L2) of memory, and external memory outside the hardware accelerator array 605 may represent a third level (L3) of memory. Memory capacity may progressively decrease with each level (e.g., memory 618 of memory tile 606 may have more storage capacity than data memory in the DPEs 610, and external memory may have more storage capacity than data memory 618 of the memory tiles 606). The hierarchical memory structure is not, however, limited to the foregoing examples.

As an example, in an artificial intelligence (AI) application, an input tensor may be relatively large (e.g., 1 megabyte or MB). Local data memory in the DPEs 610 may be significantly smaller (e.g., 64 kilobytes or KB). The controller 627 may segment an input tensor and store the segments in respective blocks of shared memory tiles 606.

FIG. 7 is a block diagram of a DPE, according to an example. In this example, FIG. 7 illustrates one implementation of the DPE 610 in the hardware accelerator array 605 illustrated in FIG. 6, according to an example. The DPE 610 includes an interconnect 705, a core 710, and a memory module 730. The interconnect 705 permits data to be transferred from the core 710 and the memory module 730 to different cores in the array. That is, the interconnect 705 in each of the DPEs 610 may be connected to each other so that data can be transferred north and south (e.g., up and down) as well as east and west (e.g., right and left) between the DPEs 610 in the array.

For example, the DPEs 610 in an upper row of the array rely on the interconnects 705 in the DPEs 610 in a lower row to communicate with the NoC 615 shown in FIG. 7. For example, to transmit data to the NoC, a core 710 in a DPE 610 in the upper row transmits data to its interconnect 705 which is in turn communicatively coupled to the interconnect 705 in the DPE 610 in the lower row. The interconnect 705 in the lower row is connected to the NoC. The process may be reversed where data intended for a DPE 610 in the upper row is first transmitted from the NoC to the interconnect 705 in the lower row and then to the interconnect 705 in the upper row that is the target DPE 610. In this manner, DPEs 610 in the upper rows may rely on the interconnects 705 in the DPEs 610 in the lower rows to transmit data to and receive data from the NoC.

In one embodiment, the interconnect 705 includes a configurable switching network that permits the user to determine how data is routed through the interconnect 705. In one embodiment, unlike in a packet routing network, the interconnect 705 may form streaming point-to-point connections. That is, the streaming connections and streaming interconnects (not shown in FIG. 7) in the interconnect 705 may form routes from the core 710 and the memory module 730 to the neighboring DPEs 610 or the NoC. Once configured, the core 710 and the memory module 730 can transmit and receive streaming data along those routes. In one embodiment, the interconnect 705 is configured using the AXI Streaming protocol. However, when communicating with the NoC, the DPEs 610 may use the AXI memory mapped (MM) protocol.

In addition to forming a streaming network, the interconnect 705 may include a separate network for programming or configuring the hardware elements in the DPE 610. Although not shown, the interconnect 705 may include a memory mapped interconnect (e.g., AXI MM) which includes different connections and switch elements used to set values of configuration registers in the DPE 610 that alter or set functions of the streaming network, the core 710, and the memory module 730.

In one embodiment, streaming interconnects (or network) in the interconnect 705 support two different modes of operation referred to herein as circuit switching and packet switching. In one embodiment, both of these modes are part of, or compatible with, the same streaming protocol—e.g., an AXI Streaming protocol. Circuit switching relies on reserved point-to-point communication paths between a source DPE 610 to one or more destination DPEs 610. In one embodiment, the point-to-point communication path used when performing circuit switching in the interconnect 705 is not shared with other streams (regardless of whether those streams are circuit switched or packet switched). However, when transmitting streaming data between two or more DPEs 610 using packet-switching, the same physical wires can be shared with other logical streams.

The core 710 may include hardware elements for processing digital signals. For example, the core 710 may be used to process signals related to wireless communication, radar, vector operations, machine learning (ML)/AI applications, and the like. As such, the core 710 may include program memories, an instruction fetch/decode unit, fixed-point vector units, floating-point vector units, arithmetic logic units (ALUs), multiply accumulators (MAC), and the like. However, as mentioned above, this disclosure is not limited to DPEs 610. The hardware elements in the core 710 may change depending on the engine type. That is, the cores in an AI engine, digital signal processing engine, cryptographic engine, or FEC may be different.

The memory module 730 includes a DMA engine 715, memory banks 720, and hardware synchronization circuitry (HSC) 725 or other type of hardware synchronization block. In one embodiment, the DMA engine 715 enables data to be received by, and transmitted to, the interconnect 705. That is, the DMA engine 715 may be used to perform DMA reads and write to the memory banks 720 using data received via the interconnect 705 from the NoC or other DPEs 610 in the array.

The memory banks 720 can include any number of physical memory elements (e.g., SRAM). For example, the memory module 730 may be include 4, 8, 16, 32, etc. different memory banks 720. In this embodiment, the core 710 has a direct connection 735 to the memory banks 720. Stated differently, the core 710 can write data to, or read data from, the memory banks 720 without using the interconnect 705. That is, the direct connection 735 may be separate from the interconnect 705. In one embodiment, one or more wires in the direct connection 735 communicatively couple the core 710 to a memory interface in the memory module 730 which is in turn coupled to the memory banks 720.

In one embodiment, the memory module 730 also has direct connections 740 to cores in neighboring DPEs 610. Put differently, a neighboring DPE in the array can read data from, or write data into, the memory banks 720 using the direct neighbor connections 740 without relying on their interconnects or the interconnect 705 shown in FIG. 7. The HSC 725 can be used to govern or protect access to the memory banks 720. In one embodiment, before the core 710 or a core in a neighboring DPE can read data from, or write data into, the memory banks 720, the core (or the DMA engine 715) requests a lock acquire to the HSC 725 when it wants to read or write to the memory banks 720 (i.e., when the core/DMA engine want to “own” a buffer, which is an assigned portion of the memory banks 720. If the core or DMA engine does not acquire the lock, the HSC 725 will stall (e.g., stop) the core or DMA engine from accessing the memory banks 720. When the core or DMA engine is done with the buffer, they release the lock to the HSC 725. In one embodiment, the HSC 725 synchronizes the DMA engine 715 and core 710 in the same DPE 610 (i.e., memory banks 720 in one DPE 610 are shared between the DMA engine 715 and the core 710). Once the write is complete, the core (or the DMA engine 715) can release the lock which permits cores in neighboring DPEs to read the data.

Because the core 710 and the cores in neighboring DPEs 610 can directly access the memory module 730, the memory banks 720 can be considered as shared memory between the DPEs 610. That is, the neighboring DPEs can directly access the memory banks 720 in a similar way as the core 710 that is in the same DPE 610 as the memory banks 720. Thus, if the core 710 wants to transmit data to a core in a neighboring DPE, the core 710 can write the data into the memory bank 720. The neighboring DPE can then retrieve the data from the memory bank 720 and begin processing the data. In this manner, the cores in neighboring DPEs 610 can transfer data using the HSC 725 while avoiding the extra latency introduced when using the interconnects 705. In contrast, if the core 710 wants to transfer data to a non-neighboring DPE in the array (i.e., a DPE without a direct connection 740 to the memory module 730), the core 710 uses the interconnects 705 to route the data to the memory module of the target DPE which may take longer to complete because of the added latency of using the interconnect 705 and because the data is copied into the memory module of the target DPE rather than being read from a shared memory module.

In addition to sharing the memory modules 730, the core 710 can have a direct connection to cores 710 in neighboring DPEs 610 using a core-to-core communication link (not shown). That is, instead of using either a shared memory module 730 or the interconnect 705, the core 710 can transmit data to another core in the array directly without storing the data in a memory module 730 or using the interconnect 705 (which can have buffers or other queues). For example, communicating using the core-to-core communication links may use less latency (or have high bandwidth) than transmitting data using the interconnect 705 or shared memory (which requires a core to write the data and then another core to read the data) which can offer more cost effective communication. In one embodiment, the core-to-core communication links can transmit data between two cores 710 in one clock cycle. In one embodiment, the data is transmitted between the cores on the link without being stored in any memory elements external to the cores 710. In one embodiment, the core 710 can transmit a data word or vector to a neighboring core using the links every clock cycle, but this is not a requirement.

In one embodiment, the communication links are streaming data links which permit the core 710 to stream data to a neighboring core. Further, the core 710 can include any number of communication links which can extend to different cores in the array. In this example, the DPE 610 has respective core-to-core communication links to cores located in DPEs in the array that are to the right and left (east and west) and up and down (north or south) of the core 710. However, in other embodiments, the core 710 in the DPE 610 illustrated in FIG. 7 may also have core-to-core communication links to cores disposed at a diagonal from the core 710. Further, if the core 710 is disposed at a bottom periphery or edge of the array, the core may have core-to-core communication links to only the cores to the left, right, and bottom of the core 710.

However, using shared memory in the memory module 730 or the core-to-core communication links may be available if the destination of the data generated by the core 710 is a neighboring core or DPE. For example, if the data is destined for a non-neighboring DPE (i.e., any DPE that DPE 610 does not have a direct neighboring connection 740 or a core-to-core communication link), the core 710 uses the interconnects 705 in the DPEs to route the data to the appropriate destination. As mentioned above, the interconnects 705 in the DPEs 610 may be configured when the SoC is being booted up to establish point-to-point streaming connections to non-neighboring DPEs to which the core 710 will transmit data during operation.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
compute circuitry configured to perform an operation that is part of a software application;
a memory controller configured to detect an uncorrectable error in data read from a memory; and
first circuitry configured to mark the data as poison data and convert the poison data into sparsity poison by zeroing out the data, wherein the compute circuitry is configured to perform the operation using the sparsity poison.

2. The system of claim 1, wherein the first circuitry is part of the memory controller or the compute circuitry.

3. The system of claim 2, wherein the first circuitry is part of the memory controller, wherein the memory controller is configured to:
determine whether to convert the poison data into sparsity data or maintain the poison data in its current state based on a memory address range associated with the read, a type of the compute circuitry, a type of the operation, or a type of the memory.

4. The system of claim 3, wherein, upon determining to maintain the poison data in its current state, the memory controller is configured to transmit the poison data to the compute circuitry, wherein the compute circuitry is configured to throw a machine check exception (MCE) which results in a software stack shutting down the operation performed by the compute circuitry.

5. The system of claim 2, wherein the first circuitry is part of the compute circuitry, wherein the compute circuitry is configured to:
determine whether to convert the poison data into sparsity data or maintain the poison data in its current state based on a memory address range associated with the read, a type of the compute circuitry, a type of the operation, or a type of the memory.

6. The system of claim 5, wherein, upon determining to maintain the poison data in its current state, the compute circuitry is configured to throw a MCE which results in a software stack shutting down the operation performed by the compute circuitry, wherein the compute circuitry does not process the poison data according to the operation.

7. The system of claim 1, wherein the operation comprises performing an matrix multiplication in the compute circuitry.

8. The system of claim 7, wherein the software application comprises an artificial intelligence (AI) training application, wherein the matrix multiplication is part of training an AI model.

9. The system of claim 8, wherein the AI training application is configured to use loss functions to evaluate gradients to determine an effect of performing the matrix multiplication using the sparsity poison has on accuracy.

10. The system of claim 1, wherein the compute circuitry is configured to generate resulting data from performing the operation using the sparsity poison, wherein the software application is configured to determine whether to continue to permit the compute circuitry to perform the operation, or to shut down the operation, based on an accuracy corresponding to the resulting data.

11. The system of claim 1, further comprising the memory, wherein the memory is at least one of dynamic random access memory (DRAM), static random access memory (SRAM), or high bandwidth memory (HBM).

12. A computing device, comprising:
a shader engine in a graphics processing unit (GPU), a core in a central processing unit (CPU), or a data processing engine (DPE) or artificial intelligence (AI) engine in a system on a chip (SoC) or a field programmable gate array (FPGA) configured to perform an operation that is part of a software application;
a memory controller configured to detect an uncorrectable error in data read from a memory; and
first circuitry configured to mark the data as poison data and convert the poison data into sparsity poison by zeroing out the data, wherein the shader engine, the core, the DPE, or the AI engine is configured to perform the operation using the sparsity poison.

13. The computing device of claim 12, wherein the first circuitry is part of (i) the memory controller or (ii) the shader engine, the core, the DPE, or the AI engine.

14. The computing device of claim 13, wherein the first circuitry is part of the memory controller, wherein the memory controller is configured to:
determine whether to convert the poison data into sparsity data or maintain the poison data in its current state based on a memory address range associated with the read, a type of the shader engine, the core, the DPE, or the AI engine, a type of the operation, or a type of the memory,
wherein, upon determining to maintain the poison data in its current state, the memory controller is configured to transmit the poison data to the shader engine, the core, the DPE, or the AI engine, wherein the shader engine, the core, the DPE, or the AI engine is configured to throw a MCE which results in a software stack shutting down the operation performed by the shader engine, the core, the DPE, or the AI engine.

15. The computing device of claim 13, wherein the first circuitry is part of the shader engine, the core, the DPE, or the AI engine, wherein the shader engine, the core, the DPE, or the AI engine is configured to:
determine whether to convert the poison data into sparsity data or maintain the poison data in its current state based on a memory address range associated with the read, a type of the shader engine, the core, the DPE, or the AI engine, a type of the operation, or a type of the memory,
wherein, upon determining to maintain the poison data in its current state, the shader engine, the core, the DPE, or the AI engine is configured to throw a MCE which results in a software stack shutting down the operation performed by the shader engine, the core, the DPE, or the AI engine, wherein the shader engine, the core, the DPE, or the AI engine does not process the poison data according to the operation.

16. A system comprising:
a memory controller configured to detect an uncorrectable error in data read from a memory and mark the data as poison data; and
compute circuitry configured to:
perform an operation that is part of a software application using the poison data to generate processed data, and
provide the processed data to the software application,
wherein the software application is configured to convert the poison data into sparsity data by zeroing out the processed data corresponding to the poison data.

17. The system of claim 16, wherein the software application is configured to determine whether to convert the processed data into the sparsity data or shut down the operation being performed by the compute circuitry based on a memory address range associated with the read, a type of the compute circuitry, a type of the operation, or a type of the memory.

18. The system of claim 17, wherein the software application converts the poison data into sparsity data only after determining the sparsity data does not have a significant impact on accuracy based on one or more thresholds.

19. The system of claim 18, wherein software application comprises an AI training application, wherein the one or more thresholds are associated with gradients corresponding to loss functions.

20. The system of claim 16, wherein the compute circuitry comprises a shader engine in a GPU, a core in a CPU, or a DPE or AI engine in a SoC or a FPGA.
